(19) United States
(12) Patent Application Publication
(10) Pub. No.: US 2013/0311403 A1
(43) Pub. Date: Nov. 21, 2013

(54) CONTONE DOMAIN COLOR PIXEL COUNTING FOR COLOR AREA COVERAGE BASED BILLING

(71) Applicants: Meng YAO, West Linn, OR (US); Xing Li, Webster, NY (US)

(72) Inventors: Meng YAO, West Linn, OR (US); Xing Li, Webster, NY (US)

(73) Assignee: Xerox Coporation, Norwalk, CT (US)

(21) Appl. No.: 13/473,250

(22) Filed: May 16, 2012

(51) Int. Cl. G06Q 30/00

(52) U.S. Cl. 705/400

(57) ABSTRACT

Disclosed herein are a method and a system implementing the method for billing using color pixel counting in documents or image in the contone domain. The method includes using the intensity or density levels (e.g., 0 to 255) for each color of each pixel of interest in the contone domain to calculate one or more probability values that one or more output colorants are provided at its location in the binary domain. The probabilities determined based on the contone color domain data are used to estimate an overall area coverage of color pixels in the document, which can be used to determine a billing structure or cost for outputting the document.

### BACKGROUND

1. Field of Invention

The present disclosure is generally related to a system and method for determining a billing structure for outputting documents based on an area color coverage estimation on a page/document. More specifically, probabilities are used to estimate the area color coverage in the contone domain.

2. Description of Related Art

Image data comprises a number of pixels having a number of components that contribute to defining the image, such as color and/or intensity. The image data generally includes various color or gray levels, which contribute to the color and/or intensity of each pixel in the image. Each pixel of the image is assigned a number or a set of numbers representing the amount of light or gray level for that color space at that particular spot, for example, the shade of gray in the pixel. Binary image data has two possible values for each pixel, black (or a specific color) (represented by the number “1”) or white (represented by the number “0”). Images that have a large range of shades are referred to as grayscale images. For example, grayscale images have an 8-bit value per pixel comprising 256 tones, or density levels, or shades of gray for each pixel in the image (gray level of 0 to 255). Grayscale image data may also be referred to as continuous tone or contone image data. The pixels in a color image may be defined in terms of a color space, typically with three values, such as RGB—R for red, G for green, and B for blue—or four values, such as CMYK—C for cyan, M for magenta, Y for yellow, and K for black.

When outputting image data to an output device (e.g., copier, printer, or multi-function device (MFD)), a percentage scale may be used to identify how much ink is employed for a print or copy job. Such information may typically be used for billing a customer for print or copy jobs. For example, some methods employ a billing strategy based on an estimated amount of ink or toner consumption; others bill customers based on a print mode selection (e.g., draft, standard, color, enhanced, etc.) of the output device. In dynamic print job environments, because printing documents using black ink or toner is less expensive than using colored ink or toner, billing is often based on the amount of color content contained in the job to be printed. In order to bill customers for color printing, color detection is an important feature required in an image path. Color detection is used to analyze documents for presence of color as well as an amount of color in order to bill customers accordingly. Generally, the higher the presence and amount of color in a document, the higher the cost.

For example, one known method for calculating how to bill for color in documents includes determining a percentage of area coverage in a document. With area coverage based billing, the counting is on a pixel by pixel basis. In other words, a pixel is counted as color if one or more of CMY colors is ON at that pixel location. Some systems include counting the number of pixels in the image data of the document to be printed in the binary domain. For example, a number of binary pixels associated with the CMYK color planes may be counted to determine a pixel count for each category of color at the time of marking for output in the image path. Generally, with existing color detection and counting methods, a pixel will be labeled as color when the presence of any one of the C, M, and Y signals is detected. U.S. patent application Ser. No. 12/252,391 (published as Patent Application No. 2010/0100505 A1), filed Oct. 16, 2008 by the same Assignee (Xerox Corporation), which is hereby incorporated by reference in its entirety, proposes a way to count color pixels.

In some cases, binary domain color content information is sometimes used with assistance from contone domain, e.g., to handle cases such as composite black. The above-referenced '505 publication, for example, has limitations in handling images that are converted to contone from rendered binary data. However, other strategies have also been introduced to improve billing of documents. For example, U.S. patent application Ser. No. 12/962,298, filed Dec. 7, 2010 by the same Assignee (Xerox Corporation, which is incorporated herein by reference in its entirety), proposes a hybrid method of counting color pixels by making use of existing hardware in the image path. In one embodiment, the normalized minimum of the two counts, one count from the CIE L*a*b neutral page based counting and the other from the CMYK based counting, is used to derive the bill.

However, in some systems, the image path may be configured to send contone data to third party marking machines. Such third party marking machines or devices may not have binary domain area based counting capabilities that can be used to determine the bill. Therefore, a contone domain area coverage based counting mechanism is needed.

### SUMMARY

One aspect of this disclosure provides a processor-implemented method for billing using color pixel counting in documents in contone domain having at least one page using an image processing apparatus. The image processing apparatus has at least one processor for processing documents containing image data comprising a plurality of pixels. The method includes the following acts implemented by the at least one processor: receiving contone image data of a document having a plurality of pixels, each pixel comprising a density level for each color in the contone domain, each color and density level in contone domain configured to be represented in binary domain using one or more output colorants, and prior to converting the contone image data to binary image data for marking the image data using one or more output colorants: calculating, for each pixel of interest, a probability value that one or more output colorants are provided at its location in the binary domain using the density levels for each color; estimating an area coverage of color pixels in the document based on the calculated probability values of the pixels of interest in the document; and determining a billing structure based on at least the estimated area coverage of color pixels in the document.

Another aspect of this disclosure includes a system for billing using color pixel counting in documents in contone domain comprising at least one page using an image processing apparatus. The system includes at least one processor having an input and an output associated with the image processing apparatus for processing pixels of received image data; wherein the at least one processor is configured to: receive contone image data of a document having a plurality of pixels, each pixel comprising a density level for each color in the contone domain, each color and density level in contone domain configured to be represented in binary domain using one or more output colorants, and prior to converting the contone image data to binary image data for marking the image data using one or more output colorants: calculate, for each pixel of interest, a probability value that one or more output colorants are provided at its location in the binary domain using the density levels for each color; estimate an area coverage of color pixels in the document based on the calculated probability values of the pixels of interest in the document; and determine a billing structure based on at least the estimated area coverage of color pixels in the document.

Yet another aspect of this disclosure includes a non-transitory computer readable medium having instructions that, when executed by a computer, directs a computer to perform a method for billing using color pixel counting in documents in contone domain using at least one processor. The method includes: receiving contone image data of a document having a plurality of pixels, each pixel comprising a density level for each color in the contone domain, each color and density level in contone domain configured to be represented in binary domain using one or more output colorants, and prior to converting the contone image data to binary image data for marking the image data using one or more output colorants: calculating, for each pixel of interest, a probability value that one or more output colorants are provided at its location in the binary domain using the density levels for each color; estimating an area coverage of color pixels in the document based on the calculated probability values of the pixels of interest in the document; and determining a billing structure based on at least the estimated area coverage of color pixels in the document.

Other features and advantages of the present disclosure will become apparent from the following detailed description, the accompanying drawings, and the appended claims.

### BRIEF DESCRIPTION OF THE DRAWINGS

FIG. 1 illustrates a method for billing using color pixel counting in documents in contone domain in accordance with an embodiment of the present disclosure;

FIG. 2 illustrates a method for determining a probability value related to presence of color for use with the method of FIG. 1; and

FIG. 3 illustrates a flow chart/block diagram illustrating exemplary processing modules in an image path for implementing the method of FIG. 1 in accordance with an embodiment of the present disclosure.

### DETAILED DESCRIPTION OF THE PREFERRED EMBODIMENT(S)

This disclosure uses algorithms, methods, and processing elements (e.g., hardware) in, e.g., multi-function systems/devices (e.g., MFDs or MFPs) to determine a billing structure taking the above problems (e.g., use of third party machines for output) into consideration by calculating area coverage of color pixels in a document in the contone domain. The determinations made in the contone domain correlate to binary domain color area coverage. The area coverage can be used to determine a cost or bill for outputting the image data of the document.

The color spaces or color planes as used herein that are associated with device independent image data, device dependent image data, binary image data, and/or contone image data should not be limiting. For example, in an embodiment, device independent image data may be processed in L*a*b, CMY, or sRGB space. Similarly, for example, in an embodiment, device dependent image data may be in CMYK space.

The term “pixel” as used herein is defined as an element of data that may be provided in any format, color space, or compression state which is associated with or readily convertible into data that can be associated with a small area or spot in an image that is printed or displayed. An image generally comprises a plurality of pixels having a number of components that contribute to defining the image when it is either printed or displayed. Generally, a pixel is defined in terms of value (or brightness or intensity) and its position in an image. Throughout this disclosure, contone image data is processed as part of the method for determining a bill. Contone images have an 8-bit value per pixel comprising 256 density levels of color, also known as intensity or shades of gray/color, for each pixel in the image (level of 0 to 255). Accordingly, a “density level” of a color as used throughout this disclosure refers to an intensity or amount of a color for a pixel in contone domain. This can sometimes be represented as a percentage of color at the location of the pixel. A pixel can have one or more colors at one or more intensities. For example, a solid green pixel may be represented by fifty percent C and fifty percent Y in a CMY contone color space. Thus, C and Y could each have a density level of fifty percent at that particular pixel location. More specifically, because each pixel is represented as an 8-bit value per pixel comprising 256 density levels, in a range including/between zero (0) to 255, then, a pixel having equal amounts of C and Y may be represented at a gray level or density level of 127 for each of C and Y.

Image data can be converted from contone domain to binary domain for marking on a page using the one or more output colorants. “Output colorant” refers to a marking material such as ink, toner, dye, or other pigment that is used for marking on a page to print image data. For example, cyan (C), magenta (M), and yellow (Y) are popular output colorants that are marked and used to represent color pixels (alone or in combination) on a page. When ready for output, binary image data is marked on YES or NO basis, i.e., yes the color is present in a pixel, or no the color is not present in a pixel. Binary image data can be device dependent.

As discussed above, some devices such as third party marking machines that are associated with a processor and/or image processing apparatus may not provide binary domain based counting capabilities that can be used to determine the bill. This disclosure provides the addition and implementation of a contone domain area coverage based counting estimation algorithm, using a probability based approach, that is used to determining a bill for outputting the document. Output colorant overlapping probabilities are calculated from the density levels in contone domain to obtain or estimate pixel counts that would correlate with the binary domain color area coverage. The calculations made in contone domain can be used alone or in combination with binary domain calculations to determine the bill. Although there are exemplary embodiments described herein, it is to be understood that such embodiments are not meant to be limiting.

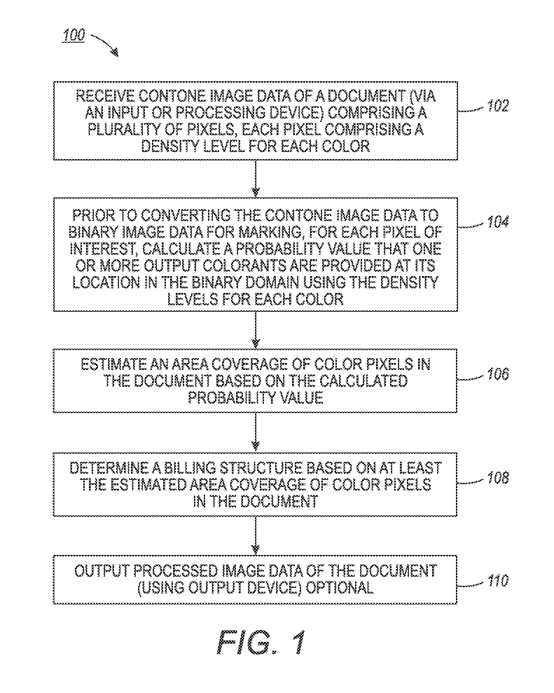

As represented in FIG. 1, the present disclosure provides a method 100 for determining a billing structure for outputting documents based on at least an estimated area coverage of color pixel in the contone domain. Generally, a billing structure is a method by which a charge to a user or customer for printing a document is calculated. A billing structure may be a calculation method associated with or correlated with tiers, thresholds, values, or algorithms, for example. A billing structure may have a direct or an indirect relation to the cost for outputting the image data/document. The billing structures used with the image processing apparatus or output device should not be limiting. In an embodiment, it is envisioned that the billing structure(s) may be determined or based on a threshold value. In another embodiment, the billing structure is based on a multi-tiered threshold value (two or more tiers). The page or document may be billed by choosing a billing structure associated with a tier based on the number of satisfied thresholds. That is, one or more thresholds may be used to separate billing tiers which may be used to charge a customer. Such multi-tier bill plans provide options to the customer which better match types of printed documents and workflows. Additionally, two-tier and three-tier meter billing plans may replace black-only and color-only billing structures, which is more satisfactory for the customer and supplier.

An example of a general setup for determining a billing structure includes using a 3-tier threshold billing structure. For example, the 3-tier color distribution may include: expressive, useful, and everyday color use. In the illustrated embodiment, the three tiers may be defined as follows: Tier-1: all black and white documents and documents with a small amount of color are billed at black and white rate; Tier-2: documents with more than a small amount of color but less than a large amount of color are billed at a lower than market color impressions rate (everyday color, level 2 impressions); Tier-3: documents with large amounts of color are bill at a competitive market color impressions rate (expressive color, level 3 impressions). To determine or separate such tiers, break-points, percentages, or thresholds may be used. In the illustrated embodiment, the thresholds dividing the tiers may be percentages of color, based on the estimated area coverage as compared to a total number of pixels, for example (e.g., overall percentage of color in the page/document). However, the percentages or thresholds and the methods of defining the percentages or thresholds that are used to determine the tiers (e.g., ratio, percentage, pixel count) should not be limiting.

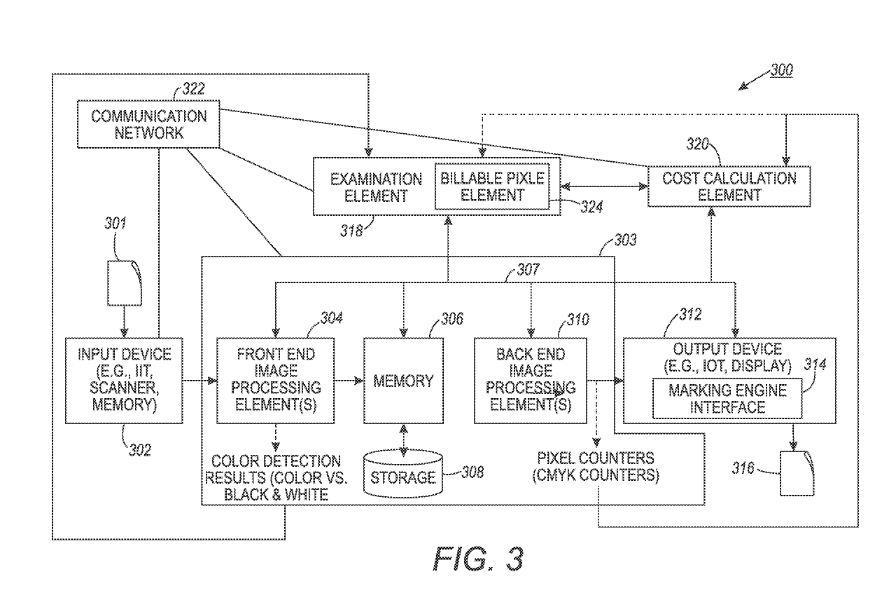

Referring back to FIG. 1, illustrated is a flow chart/block diagram illustrating a method for billing using color pixel counting in documents in contone domain in accordance with an embodiment of the present disclosure. Each of the method steps that are shown in FIG. 1 and throughout this disclosure may be implemented by a computer or a processor, for example, and are not meant to be limiting. For example, the elements or modules as shown in FIG. 3 may implement the herein described methods.

Method 100 begins at 102 in which a processor and/or image processing apparatus receives a document comprising at least one page of image data. The image data comprises a plurality of pixels. The received image data in 102 is representative of any type of page or document and may include a variety of objects to be detected and used by method 100; however, method 100 may use a document that includes any combination of objects (including text). It should be understood to one of ordinary skill in the art that the image data may undergo several processing steps including, but not limited to, transforming the input image data into a device independent space or contone data, for example, among other steps that are known in the art and not discussed in detail here. The image data can be provided or converted to data in the contone domain. As shown at 102, the received contone image data is processed. In the contone domain, the plurality of pixels of image data can be represented by one or more colors that are configured for transformation into the binary domain when ready for output by an output device. Each pixel comprises a density level for each color in the contone domain. Each color and density level in contone domain is configured to be represented in binary domain using one or more output colorants.

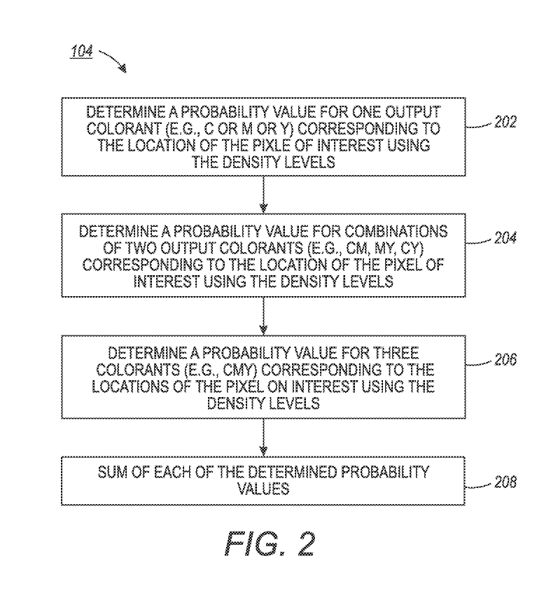

Prior to converting the contone image data to binary image data for marking the image data using (with a particular device) the one or more output colorants, the pixels of interest are processed in the contone domain, as shown at 104. A pixel of interest can be each pixel of the image data, e.g., processing on a pixel-by-pixel basis, or a select or representative amount of pixels in the image data. For each pixel of interest, a probability value is calculated. The probability value is determined based on the probability that one or more output colorants (alone or in combination) are provided at its location in the binary domain, i.e., the probability that a color will be printed using colorant (once converted to binary) is determined. In an embodiment, the density levels of each color in the contone domain are used to determine the probability value. The probability value of a pixel having one or more colorants when output can be based on one or more determinations or calculations. FIG. 2, described below, illustrates in greater detail one embodiment of a method used for determining the probability value of a pixel of interest for having color. Then, based on the calculated probability values of each of the pixels of interests in the image data determined at 104, an area coverage of color pixels in the document is estimated at 106.

In an embodiment, the average coverage of color pixels at 106 is an approximated or estimated count of color pixels in the image data. For example, in one embodiment, the probability values for the individual pixels of interest can be summed to determine a total (estimated) count of color pixels in the image data. The total count of color pixels determines the area coverage of the image data (in a page, per page, or document).

After the area coverage estimation 106, a billing structure is determined at 108 based on at least the estimated area coverage of color pixels per page and/or in the document. In one embodiment, it is also envisioned that the estimated area coverage determined at 106 can be used with binary domain color content information in a hybrid method to count or estimate area coverage of color pixels in the page and/or document.

Optionally, after the billing structure is determined at 108, the processed image data may be optionally marked and output using an output device or IOT, as shown at 110. The output device can be associated with the image processing apparatus or processor. In an embodiment, the output device includes the marking device for marking output colorants on a page (including black or K), and is a part of the processing apparatus. In another embodiment, the output device/marking device is part of system that is associated with the processor, e.g., it is a third party marking device. It may be in communication with a processor that is provided at a remote location, for example. Additional details regarding the processor(s) (also referred to as processing modules or elements) and devices are provided with reference to FIG. 3.

Again, the contone colors, output colorants and color spaces used for processing the steps of method 100 are not meant to be limiting. Although C, M, and Y are used to describe the colors in contone domain and the output colorants in the examples above and below, it should be understood that additional or alternative colorants may be used for color pixel counting/estimating.

As previously noted, FIG. 2 illustrates a method which can be used for determining the probability value that a pixel of interest has color in its location in the binary domain. Specifically, in accordance with an embodiment, calculating a probability value as shown at 104 comprises determining a first probability value calculation for one output colorant (e.g., C, M, or Y) corresponding to the location of the pixel of interest at 202, determining a second probability value calculation for combinations of two output colorants corresponding to the location of the pixel of interest at 204, and/or determining a third probability value calculation for three output colorants corresponding to the location of the pixel of interest at 206 (when the pixel is marked for output). In an embodiment, to calculate the probability value, the determinations at 202-206 are combined. That is, as shown at 208, a sum of each of the first, second, and third determined probability value calculations is calculated for the overall probability value of the pixel of interest having color.

In an embodiment, each of the determinations 202-206 use the density levels of each of the colors in contone domain in their calculations. For example, in the case of C, M, and Y as the output colorants, the density levels for each C, M, and Y color in contone for a pixel of interest can be determined/calculated by the processor. The formula below show the calculations that are made for 202-206, for example. The density levels (represented as dC, dM, dY) are scaled from a range of [0, 255] to a range of [0, 1]. Such a range correlates to a dot percentage in the range of 0 to 100%, for use as the print image data.

(a) One colorant (C or M or Y printed at the pixel location) probability:

Prob1=dC*(1−dM)*(1−dY)+dM*(1−dC)*(1−dY)+dY*(1−dC)*(1−dM)

(b) Two colorants (MY or CY or CM printed at the pixel location) probability:

Prob2=(1−dC)*dM*dY+(1−dM)*dC*dY+(1−dY)*dC*dM

(c) Three colorants (CMY printed at the pixel location) probability:

Prob3=dC*dM*dY

wherein:

Prob1, Prob2, and Prob3 are defined as probabilities correlating to one colorant, two colorants, and three colorants, respectively, printed at the location of the pixel of interest;

dC is defined as a (scaled) density level of cyan for the pixel of interest;

dM is defined as a (scaled) density level of magenta for the pixel of interest; and

dY is defined as a (scaled) density level of yellow for the pixel of interest.

By determining the probability of having one color, two colors, and three color at the pixel location when marked, an overall probability value related to the pixel of interest having color can be calculated.

The sum of the three probability values is used to represent the contribution of the pixel toward the overall color area coverage count. Overall probability of a pixel having color (OverallProb) is the sum of the above three counts, i.e.:

OverallProb=Prob1+Prob2+Prob3, which, after simplification, is:

OverallProb=dC+dM+dY−dC*dM−dC*dY−dM*dY+dC*dM*dY

The following is a numerical example of determining a (overall) probability value that one or more colorants are provided at a location of a pixel of interest using the density levels (from contone domain) for each color:

### EXAMPLE

For a pixel of interest, the density levels for cyan, magenta, and yellow are C=0.3, M=0.5, Y=0.6, respectively. Thus,

Prob1=0.3*(1−0.5)*(1−0.6)+0.5*(1−0.3)*(1−0.6)+0.6*(1−0.3)*(1−0.5)=0.06+0.14+0.21=0.41

Prob2=0.7*0.5*0.6+0.5*0.3*0.6+0.4*0.3*0.5=0.21+0.09+0.06=0.36

Prob3=0.3*0.5*0.6=0.09

OverallProb=0.41+0.36+0.09=0.86

Or, using the simplified equation for OverallProb:

Count=0.3+0.5+0.6−0.3*0.5−0.3*0.6−0.5*0.6+0.3*0.5*0.6=0.86

i.e., the overall probability that this pixel of interest will have color when marked using output colorant(s) is approximately 86 percent (%).

The overall probability for the pixel of interest is used to estimate the overall area coverage of color in the page and/or document (when printed or copied), which, in turn, is used for billing.

As noted previously, in one embodiment, the estimated overall area coverage of color pixels in the page and/or document can be used to determine a total color pixel count in the page and/or document by summing up the calculated probability values of all of the pixels of interest in the page and/or document. That is, each pixel of interest's probability can be summed to determine a total (estimated) color pixel count. For example, if an image on a page has four total pixels, all which are pixels of interest that are processed, and the overall probabilities of the first, second, third, and fourth pixels having color are 0.5, 0.3, 0.9, and 0.6, respectively, then the total area coverage is=0.5+0.3+0.9+0.6=2.3 color pixels. The sum of the probabilities can be used directly as noted above, or, in another embodiment, indirectly and/or with other factors, to determine a total color pixel count(s).

Each of the probabilities enable further processing of the pixels (and groups or areas of pixels) and determinations based on areas of color on a page and/or in the document. Such information is used for estimation of color area coverage in the page/document. For example, the area coverage estimation can be used to determine an overall amount of color in a document. In an embodiment, the area coverage estimation determines a percentage of color in each page (e.g., percentage of color pixels (e.g., from summed probabilities) as compared to a total number of pixels in the page). As an example, for an 8.5×11 page at 600×600 dpi, the total number of pixels is approximately 33660000. A page of image data is received and processed. If the sum of the probabilities adds up to 5049000, then the percentage of color in the page would be 5049000/33660000*100=approximately 15 percent(%)estimated area coverage of color in the page. This percentage could be used to determine the amount for billing for outputting the page (or document). In another embodiment, the area coverage estimation is used to determine the presence of color objects in a page and/or document, and/or the type of objects in a document, including, but not limited to, monochrome contone objects, monochrome text objects, monochrome line art, monochrome graphic objects, monochrome halftone objects, monochrome solid fill objects, color contone objects, color text objects, color line art objects, and/or color solid fill objects. Such determinations can be used when determining the billing structure at 108, for example.

Accordingly, the herein disclosed method enables use of probability technique in the contone domain to calculate pixel overlapping upon marking. The probabilities can be used to calculate pixel overlapping because color halftone dots (binary data) overlap randomly over an area. Because of such overlap (colors dots should not be correlated, otherwise there would be hue shifts in an uniform area due to misregistration), when the counts or probabilities are added up over an area, the counts or approximated area of color coverage of color pixels resulting from the probability value are substantially accurate.

Benefits of the method 100 include the ability to provide area coverage based billing when contone data is sent to third party marking machines. For example, such a method 100 can be used to determine a billing structure when data is sent to output devices and/or processors without binary domain counting methods. Also, image data in the contone domain includes additional information pertaining to image data as compared to the binary domain (e.g., contone data includes more information related to edges). Such information can be used to more accurately determine usage of marking material when the image data is output, for example. However, as noted previously, the method 100 can also be used with, in addition to, or in combinations with binary domain color coverage methods to determine the bill for outputting document(s).

The herein described methods may be used or implemented by any MFD (or printer or copier) manufacturing companies that wish to implement image paths capable of counting color pixels in contone domain. Existing processors and/or controllers can be used to implement the algorithm shown in FIG. 1. Alternatively, one or more hardware or software modules can be easily added to an existing image path for its implementation.

FIG. 3 illustrates a block diagram of an example of an image path 300 for processing image data as disclosed herein of a system, device or image processing apparatus 303, such as an MFD. The system/device/apparatus 303 comprises, among other devices, an input device (e.g., IIT or memory) 302, a processor or processing elements represented by 304 and 310, a memory 306 and/or a storage device 308. Associated with apparatus 303 is an output device (e.g., IOT) 314 that includes marking engine interface 312. The apparatus 303 communicates with output device 314 via an image path. In an embodiment, the output device 314 is included in the apparatus. In another embodiment, the output device 314 is a third party device that is separate from the processor(s) and/or apparatus 303.

The image path 300 of the system 303 may also include an examination element 318 and/or cost calculation element 320 which may be a part of the system 303 itself or in communication with the processing elements 304 and 310, for example. Generally, the above elements (as will be described) of the device are provided to perform functions that assist in receiving image data such as a scanned document, configuring the image path of the processing elements 304 and 310 (and possibly elements 318 and 320) to process the image data, and, if needed, outputting the image data such as by printing a document according to an output mode that may be selected. However, it should be noted that the apparatus or device may comprise additional elements not described herein or alternative elements for performing similar functions, and should not be limited to those elements as illustrated in FIG. 3.

The input device 302 is used to deliver image data of a document to the system 303 and/or processing elements in the image path. In some embodiments, the input device 302 is used to scan or acquire an input document 301 or page into image data, such as when copying a document, for example. The input device 302 may be a digital scanner, for example. Generally, however, any device used to scan or capture the image data of a document for an image processing apparatus may be used. For example, the image data may be captured by a scanner in a copier, a facsimile machine, a multi-function device, a camera, a video camera, or any other known or later device that is capable of scanning a document and capturing and/or inputting electronic image data. The input device 302 may include submission of electronic data by any means and should not be limiting. In other embodiments, the input device 302 may be an electronic device for inputting electronic image data. In some embodiments, input device 302 may be connected to a network 322 or telephone system, for example, to receive as input image data such as via a facsimile (fax) machine or computer (CPU). Input documents and/or image data that is received electronically may be received via a telephone number, an e-mail address, an Internet Protocol (IP) address, a server, or other methods for sending and/or receiving electronic image data. The network may be a digital network such as a local area network (LAN), a wide area network (WAN), the Internet or Internet Protocol (IP) network, broadband networks (e.g., PSTN with broadband technology), DSL, Voice Over IP, WiFi network, or other networks or systems, or a combination of networks and/or systems, for example, and should not be limited to those mentioned above.

If needed, the input or received image data may be converted using the input device 302 and/or processing elements in the apparatus 303. For example, in embodiments, the image data may be converted from device dependent space to device independent space (e.g., sRGB to L*a*b), or between contone and binary data. Alternatively, the image data may be received in device independent space (e.g., L*a*b or PostScript). The type of image data received and the type of input devices documents are received therefrom should not be limiting.

In any case, the input device 302 may capture image data as binary or contone image data, for example. Generally, when the input image data from the input device is received in device dependent space, the processing elements in the image path will typically convert such image data to some device independent space for further processing before converting the image data to device dependent space (e.g., to be output). Nonetheless, as noted above, the method 100 is implemented before conversion to binary, i.e., on image data in contone domain, to estimate area color coverage in the document before marking. Such contone data can be device independent or dependent. Accordingly, one or more processing elements in apparatus 303 may be used for such a calculation.

FIG. 3 also shows one or more processors or processing elements for processing and/or manipulating image data using a plurality of operations and/or processes. The description of the processing elements below is an example of devices capable of implementing processes to be performed and should not be limiting. For example, additional processing elements may be provided along the image path 300, including, but not limited to, pixel counters used to count pixels in the binary domain. Additionally and/or alternatively, additional operations may be performed on the image data other than or in addition to those described herein.

The image path 300 of system 303 may comprise one or a plurality of image processing elements (or processor(s)) for manipulating image data received from the input device 302 using a plurality of operations and/or processes. The processing elements may be a combination of image processing elements which comprise software and hardware elements that perform a number of operations on the image data received from the input device 302 (e.g., IIT/scanner, memory, or other source) using a set of parameters. The processing elements may be a part of a computer system, device, or apparatus such as a xerographic system, a photocopier, a printing device, or a multi-function device (MFD). The terms “processing element” or “processor” are used interchangeably throughout this disclosure and refer to one or more elements capable of executing machine executable program instructions. It is to be understood that any number of processing elements may be used and that additional operations or processes besides those described below may be provided in an image path.

More specifically, the image path of FIG. 3 comprises a front end processing element(s) 304, a memory 306, storage 308, and a back end processing element(s) 310. Each of the devices or elements in the image path may communicate with each other, as represented by path 307. The front end processing element(s) 304 may comprise any number of processing elements/modules and is/are image processing elements that receive image data in a beginning of an image path and is/are used to process the image data according to user preferences such that it may be stored and later retrieved for output and according to the method described herein. The back end processing element(s) 310 may comprise any number of processing elements/modules and can be generally used at the end of an image path to retrieve stored image data and to process the image data such that the image data may be output to a printing device as an accurate recreation of the original input or scanned image. Of course, processing elements may also be used for compression and/or decompression of image data.

In an embodiment, one or more of the elements (e.g., processing elements 304, 310 and memory 306/storage 308) of system 303 may be connected to a network 322 or telephone system, for example, for communication with other devices, systems, or apparatuses. For example, in some cases, image data or executable instructions may be provided via a computer (CPU) connected to the network 322. As further described below, in a possible embodiment, at least one processing element of system 303 may implement an operative set of processor executable instructions of a billing system. Such a billing system or the executable instructions may be provided via the network 322, for example.

Each of the image processing elements comprises an input and an output. Additionally, the system, device, or apparatus may also include one or more controllers or routers (not shown) to select and route the image data between the processing elements 304 and 310 and memory 306 and/or storage 308, and other elements described below, for example.

Front end processing element(s) 304 receives (e.g., as input) the image data from the input device 302 and processes the image data. The image data may be received as input via a scanning engine interface, for example, such as when copying and turning a hard copy document into image data. Alternatively, the image data may be received electronically, such as from a memory device, storage device (portable or remote), et al., such as when printing a saved document. As such, the form in which image data is received should not be limiting. Front end processing element(s) 304 may be used to process the scanned image data as well as determine user-defined operations generally known in the art. Memory 306 and/or storage 308 may be used to store image data. For example, memory 306 and/or storage 308 may be used to temporarily store the original image data of document input via input device 302. Converted (e.g., binary to contone image data) or compressed image data may also be stored in the memory 306 and/or storage 308. Memory 306 and/or storage 308 may be used to store machine readable instructions to be executed by the processor/processing elements. The memory 306 and/or storage 308 may be implemented using static or dynamic RAM (random access memory), a floppy disk and disk drive, a writable optical disk and disk drive, a hard disk and disk drive, flash memory, or the like, and may be distributed among separate memory components. The memory 306 and/or storage 308 can also include read only memory, or other removable storage drive(s) or memory devices.

The front end processing element(s) 304 may communicate with memory 306 and/or storage 308 of system/apparatus 300 to store processed and/or compressed image data, for example. Compressed image data may be stored in memory 306 and/or storage 308 temporarily or for a later time when needed. When the image data is needed or it is time for marking (e.g., using the marking engine interface 312 or output device 314), the image data may be retrieved from memory 306 and/or storage 308 via the back end processing element(s) 310 to export the image data, for example.

Back end processing element(s) 310 receives processed image data from the memory 306 or storage 308. Back end processing element (s) 310 may be used to further render the image data for output. For example, back end processing element 310 may be used to convert the color space of the processed image data (e.g., convert from device independent CIE L*a*b color space to device dependent CMYK color space), provide color balance, further rendering, filtering, and/or other operations or processes. Subsequently, back end processing element(s) 310 may be used to decompress the image data and output the image data to output device 314. The output of processed image data from the back end processing element 310 depends on the image path (or output mode).

In an embodiment, the back end processing element(s) 310 may be used for calculating the estimation of CMY area color coverage in the contone domain, as shown by method 100 in FIG. 1, before converting the image data to binary for output. In another embodiment, front end processing element(s) 304 are used to perform the determinations of the method shown in FIG. 1.

In an embodiment, the processed image data may be directly output to the marking engine interface 312 for printing using an output device 314. The marking engine interface 312 and/or output device 314 may be associated with a printer, a copier, or an MFD which is used for printing documents, or incorporated therein. In some cases, the marking engine interface may be a part of the output device 314. The marking engine interface 312 may be designed to receive the reconstructed and processed image data in device independent space or device dependent space. The marking engine interface 312 may further perform image processing on the image data to make corrections or compensate for deviation in the printing process. Alternatively, the back end processing element(s) 310 may be used to perform further image processing on the image data.

The type of output device 314 should not be limiting. For example, the output device 314 may comprise an image output terminal (IOT), display, screen, printing device, copying device, MFD, or others devices, as generally noted above. Output device 314 may include a display or screen. The display or screen may be a part of a computer (CPU) or user interface (UI) or may be provided to relay information from a website or other device via a network 322, for example. In some cases, a UI may be provided directly on the apparatus/device, while in others a UI is provided as a separate electronic device.

It should be noted that the output print quality of image data from an output device 314 such as a MFD may depend the type of system or device (and its available output modes/resolution). In some cases, multiple print quality modes (PostScript driver), each with a different resolution, are supported. In an embodiment, the processed image data may be output to a printer (e.g., drum or roll for applying to paper) to complete the image path, for example. Of course, the algorithms and processes used by the elements in the image path shown in FIG. 3 should not be limiting.

In an embodiment, the system or apparatus 303 may further comprise one or more elements for determining a billing structure and/or a cost for outputting a page or document via an output device such as device 314. For example, as shown in FIG. 3, an examination element 318 and/or cost calculation element 320 may be provided. In an embodiment, the examination element 318 and/or cost calculation element 320 may be a part of the image path of the system 303. In an embodiment, the elements 318 and/or 320 are separate from the image path of the system 303. In an embodiment, the features, calculations, and/or determinations provided by examination element 318 and/or cost calculation element 320 may be incorporated into one or more processing elements, such as elements 304, 310, or 312, and therefore such elements should not be limited to the illustrated embodiment.

Examination element 318 may be configured to examine the image data. The examination element 318 may assist in determining the billable pixel count of color pixels in the image data (based on at least the area coverage estimation). For example, the examination element 318 may comprise a billable pixel element 324 that is configured to perform any of the calculating and/or counting steps such as shown in method 100 and/or method 200.

The examination element 318 may operatively communicate with a cost calculation element 320. The cost calculation element 320 is configured to calculate a billing cost or an approximate cost for outputting the page and/or document of image data using the area coverage estimation. The billing cost may be calculated and based on a determined billing structure. The billing structure may be determined by either the examination element 318 or the cost calculation element 320, for example.

In an embodiment, the billing cost is further calculated based on a type of output device to be used. For example, when printing to a printer or MFD, the chosen type of output device may alter the cost for printing the page or document due to the plurality of output modes, inks, toners, and other elements which contribute to the quality of the output document 316. In an embodiment, the cost calculation element 320 is configured to operatively communicate with the examination device 318 and at least one of the processing elements (such as 310 or 312) to calculate a billing cost for outputting the page and/or document.

In a possible embodiment, examination element 318 and cost calculation element 320 are part of a billing system to be implemented by an operative set of processor executable instructions configured for execution by at least one processor or processing element. The billing system may be provided at a remote location with respect to the at least one processor. In an embodiment, the at least one processor is provided in an image processing apparatus, which may comprise an input device for inputting image data and an output device for outputting image data. In an embodiment, the at least one processor of the billing system is provided at a remote location with respect to an output device. As noted above, at least one processing element of system 303 may implement the operative set of processor executable instructions of the billing system by communicating via the network 322, for example. The at least one processing element may thus be provided in the same or a remote location with respect to the output device. In some cases, the examination element 318 and/or cost calculation element 320 may communicate an approximate cost or billing cost to the processor/system 303. In some cases, the examination element 318 and/or cost calculation element 320 may be a part of the processor which communicates with system 303 or an output device.

In a possible embodiment, the cost calculated by the cost calculation element 320 (or its associated processing element) may be sent directly to the output device 314. For example, as shown in FIG. 3, the cost calculation element may communicate via path 307 the approximate billing cost to the output device 314. In this case, the cost may be output via a display, screen, or even a print job. By providing the cost in such a manner—i.e., before outputting the image data via a printing or copying output device—the customer can decide if the image data should be marked via interface 312 and output device 314, or if the data should be saved/discarded (e.g., such as if the cost is too high). The customer may choose to optionally output the image data (e.g., via contact with network 322 or system 303) through the use of an activation button after reviewing the cost, for example.

Other embodiments include incorporating the above methods into a set of computer executable instructions readable by a computer and stored on a data carrier or otherwise a computer readable medium, such that the method 100 is automated. In a possible embodiment, the methods may be incorporated into an operative set of processor executable instructions configured for execution by at least one processor. FIG. 1 and FIG. 2 each show a flow chart of such computer readable instructions. For example, in some embodiments, memory or storage of an output device carrying instructions is configured such that when the executable instructions are executed by a computer or processor, they cause a computer or processor to automatically perform a method for determining color content in documents and/or a billing structure for outputting documents. Such instructions may be contained in memory 306, for example. In alternative embodiments, hard-wired circuitry may be used in place of or in combination with software instructions to implement the disclosure. Thus, embodiments of this disclosure are not limited to any specific combination of hardware circuitry and software. Any type of computer program product or medium may be used for providing instructions, storing data, message packets, or other machine readable information associated with the methods 100. The computer readable medium, for example, may include non-volatile memory, such as a floppy, ROM, flash memory, disk memory, CD-ROM, and other permanent storage devices useful, for example, for transporting information, such as data and computer instructions. In any case, the medium or product should not be limiting.

The system 303 may be a computer system which includes a bus or other communication mechanism for communicating information, and one or more of its processing elements may be coupled with the bus for processing information. Also, the memory 306 may comprise random access memory (RAM) or other dynamic storage devices and may also be coupled to the bus as storage for the executable instructions. Storage device 308 may include read only memory (ROM) or other static storage device coupled to the bus to store executable instructions for the processor or computer. Alternatively, another storage device, such as a magnetic disk or optical disk, may also be coupled to the bus for storing information and instructions. Such devices are not meant to be limiting.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will be appreciated that various of the above-disclosed and other features and functions, or alternatives thereof, may be desirably combined into many other different systems/devices or applications. Various presently unforeseen or unanticipated alternatives, modifications, variations, or improvements therein may be subsequently made by those skilled in the art which are also intended to be encompassed by the following claims.

What is claimed is:

1. A processor-implemented method for billing using color pixel counting in documents in contone domain comprising at least one page using an image processing apparatus, the image processing apparatus comprising at least one processor for processing documents containing image data comprising a plurality of pixels, the method comprising the following acts implemented by the at least one processor:
receiving contone image data of a document comprising a plurality of pixels, each pixel comprising a density level for each color in the contone domain, each color and density level in contone domain configured to be represented in binary domain using one or more output colorants, and
prior to converting the contone image data to binary image data for marking the image data using one or more output colorants:
calculating, for each pixel of interest, a probability value that one or more output colorants are provided at its location in the binary domain using the density levels for each color;
estimating an area coverage of color pixels in the document based on the calculated probability values of the pixels of interest in the document; and
determining a billing structure based on at least the estimated area coverage of color pixels in the document.

2. The method according to claim 1, wherein the calculating a probability value comprises: determining a first probability value calculation for one output colorant corresponding to the location of the pixel of interest, determining a second probability value calculation for combinations of two output colorants corresponding to the location of the pixel of interest, and/or determining a third probability value calculation for three output colorants corresponding to the location of the pixel of interest.

3. The method according to claim 2, wherein the calculating a probability value comprises: summing the first, second, and third determined probability value calculations.

4. The method according to claim 1, wherein the estimating the area coverage of color pixels in the document comprises: determining a total color pixel count in the document by summing the calculated probability values of the pixels of interest in the document.

5. The method according to claim 1, wherein the output colorants are cyan (C), magenta (M), and yellow (Y).

6. The method according to claim 1, wherein the determined billing structure is based on a multi-tiered threshold value, and wherein the determining the billing structure comprises selecting a billing tier at which to bill for outputting the received image data based on at least the estimated area coverage of color pixels.

7. The method according to claim 6, wherein the image processing apparatus further comprises a cost calculation element for calculating billing costs, and wherein the method further comprises:
calculating a billing cost for outputting the document using the cost calculation element based on at least the estimated area coverage of color pixels and the selected billing tier.

8. The method according to claim 1, wherein the image processing apparatus further comprises an input device for inputting documents, and wherein the method further comprises:
receiving the image data of the document using the input device, the input device being selected from the group consisting of: an image input terminal, a memory device, or a storage device.

9. The method according to claim 1, wherein the image processing apparatus is associated with an output device for outputting documents, and wherein the method further comprises:
outputting the processed image data of the document using the output device.

10. A system for billing using color pixel counting in documents in contone domain comprising at least one page using an image processing apparatus, the system comprising:
at least one processor comprising an input and an output associated with the image processing apparatus for processing pixels of received image data;
wherein the at least one processor is configured to: receive contone image data of a document comprising a plurality of pixels, each pixel comprising a density level for each color in the contone domain, each color and density level in contone domain configured to be represented in binary domain using one or more output colorants, and prior to converting the contone image data to binary image data for marking the image data using one or more output colorants: calculate, for each pixel of interest, a probability value that one or more output colorants are provided at its location in the binary domain using the density levels for each color; estimate an area coverage of color pixels in the document based on the calculated probability values of the pixels of interest in the document; and determine a billing structure based on at least the estimated area coverage of color pixels in the document.

11. The system according to claim 10, wherein the calculation of the probability value is determined using: a first probability value calculation for one output colorant corresponding to the location of the pixel of interest, a second probability value calculation for combinations of two output colorants corresponding to the location of the pixel of interest, and a third probability value for three output colorants corresponding to the location of the pixel of interest.

12. The system according to claim 11, wherein the calculation of the probability value is determined by a sum of the first, second, and third determined probability value calculations.

13. The system according to claim 10, wherein the estimation of the area coverage of color pixels in the document comprises the processor being configured to: determine a total color pixel count in the document using a sum of the calculated probability values of the pixels of interest in the document.

14. The system according to claim 10, wherein the output colorants are cyan (C), magenta (M), and yellow (Y).

15. The system according to claim 10, wherein the determined billing structure is based on a multi-tiered threshold value, and wherein the determination of the billing structure comprises selection of a billing tier at which to bill for outputting the received image data.

16. The system according to claim 15, wherein the system further comprises: a cost calculation element for calculating a billing cost for outputting the document based on at least the estimated area coverage of color pixels and the selected billing tier.

17. The system according to claim 10, wherein the system further comprises an input device for inputting documents containing image data to the at least one processor, the input device being selected from the group consisting of: an image input terminal, a memory device, or a storage device.

18. The system according to claim 10, wherein the image processing apparatus is associated with an output device for outputting processed image data of the document using the output device, the output device being selected from the group consisting of: an image output terminal, a display, a printing device, a copying device, or a multi-function device.

19. A non-transitory computer readable medium comprising instructions that, when executed by a computer, directs a computer to perform a method for billing using color pixel counting in documents in contone domain using at least one processor, the method comprising:
receiving contone image data of a document comprising a plurality of pixels, each pixel comprising a density level for each color in the contone domain, each color and density level in contone domain configured to be represented in binary domain using one or more output colorants, and
prior to converting the contone image data to binary image data for marking the image data using one or more output colorants:
calculating, for each pixel of interest, a probability value that one or more output colorants are provided at its location in the binary domain using the density levels for each color;
estimating an area coverage of color pixels in the document based on the calculated probability values of the pixels of interest in the document; and
determining a billing structure based on at least the estimated area coverage of color pixels in the document.

20. The medium according to claim 19, wherein the calculating a probability value comprises: determining a first probability value calculation for one output colorant corresponding to the location of the pixel of interest, determining a second probability value calculation for combinations of two output colorants corresponding to the location of the pixel of interest, and/or determining a third probability value calculation for three output colorants corresponding to the location of the pixel of interest.

21. The medium according to claim 20, wherein the calculating a probability value comprises: summing the first, second, and third determined probability value calculations.

22. The medium according to claim 19, wherein the estimating the area coverage of color pixels in the document comprises: determining a total color pixel count in the document by summing the calculated probability values of the pixels of interest in the document.

23. The medium according to claim 19, wherein the determined billing structure is based on a multi-tiered threshold value, and wherein the determining the billing structure comprises selecting a billing tier at which to bill for outputting the received image data based on at least the estimated area coverage of color pixels.
